(19) United States
(12) Patent Application Publication
(10) Pub. No.: US 2018/0242668 A1
(43) Pub. Date: Aug. 30, 2018

(54) A FASTENING DEVICE FOR A ROPE-LIKE MATERIAL USED AS A PART OF A BELT

(71) Applicant: Troy Earnshaw, Engadine (AU)

(72) Inventor: Troy Earnshaw, Engadine (AU)

(21) Appl. No.: 15/553,451

(22) PCT Filed: Feb. 24, 2015
(86) PCT No.: PCT/AU2015/050072

§ 371 Date: Aug. 24, 2017

(51) Int. Cl. A41F 9/00; A44B 11/25; A44B 11/00; F16G 11/14

(52) U.S. Cl. CPC A41F 9/002; F16G 11/14; A44B 11/008; A44B 11/25

(57) ABSTRACT

A fastening device including a first part having a material engagement portion, the material engagement portion including a stem for receiving a loop of an elongate portion of material, and a second part, wherein the first part is releasably engageable with the second part. The fastening device is typically for joining elongate portions of material such as ropes, belts or the like.

### FIELD OF THE INVENTION

The present invention relates to a fastening device and in particular, a fastening device for a rope or rope-like material that may be used as part of a belt.

### BACKGROUND OF THE INVENTION

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

In the past, belts have typically kept the same functional structure and appearance. They generally comprise an elongate flat piece of material which includes a buckle end having a buckle, and a tongue end including adjuster holes. In use, the belt is placed around a wearers waist and the tongue end fed through the buckle until a desired circumference is achieved, at which point, the buckle is engaged with one of the adjuster holes. The engagement between buckle and adjuster hole may be via a rigid buckle prong, stud or other member inserted in the adjuster hole. In addition, the portion of the tongue end that has been fed through buckle may be retained from flapping around via insertion through a retaining loop, attached to the body of the belt, which keeps the tongue end adjacent the wearer's waist.

Despite being relatively common, belts have some technical problems. For example, the buckle is typically irreversibly fastened to the material body of the belt. This makes it difficult for a wearer to customise their belt and/or interchange buckles between different belt bodies. In addition, the adjuster holes are prone to stretching or rupture, such that the belt can no longer be fastened at the desired length.

Another problematic issue is that the rigid buckle tongue is often exposed, and therefore prone to catching on clothing or other structures, and may even snap off. Aesthetically, the belt material is also typically limited to being of a flat and elongate shape.

The present invention seeks to a provide a fastening device, for use with belts or otherwise that addresses the above mentioned issues.

### SUMMARY OF THE INVENTION

In one broad form, the present invention provides a fastening device including: a first part having a material engagement portion, the material engagement portion including a stem for receiving a loop of an elongate portion of material; and a second part, wherein the first part is releasably engageable with the second part.

In one form, the material engagement portion includes a recess, the stem extending substantially from a first wall portion of the recess to a second wall portion of the recess so as to provide an anchor for the loop of the elongate portion of material.

In another form, the first part includes a base part and a cover part, the first wall portion forming part of the base part and the second wall portion forming part of the cover part.

In one form, the base part and cover part are moveable into a loading configuration, wherein the stem does not substantially extend between the first and second wall portions, and a closed configuration wherein the stem extends substantially between the first and second wall portions.

In another form, all of the stem extends from the first wall portion providing a stem tip for placement adjacent to the second wall portion.

In one form, the base and cover parts are movable between the loading configuration and closed configuration via a sliding engagement/disengagement.

In another form, the second wall portion includes a groove to receive and support the stem tip.

In a further form, the cover part is sleeve-like.

In another form, the base part includes a protrusion and the cover part includes a corresponding depression in an internal wall such that the base and cover parts substantially snap engage in the closed configuration.

In one form, the base part includes a curved wall portion to help guide the elongate portion of material around the stem.

In another form, the base part includes a first wedge portion and the cover part includes a second wedge portion, such that, in the closed configuration, the first and second wedge portions clamp the loop of elongate material around the stem.

In a further form, the cover part includes first and second opposing wedge portions such that, in the closed configuration, the wedge portions clamp the loop of elongate material around the stem.

In one form, the first and second parts are twist engaged.

In another form, the second part includes a material engagement portion as defined in any one of the preceding claims in relation to the first part.

In one form, the fastening device is a belt buckle.

In a further broad form, the present invention provides a belt including a fastening device as described in any one of the above forms.

In one form, the present invention provides a belt wherein the first and second parts of the fastening device are releasably engaged to respective portions of a rope-type material.

In another broad form, the present invention provides a belt including a fastening device wherein the first part is releasably engaged to a first portion of rope-type material and the second part is fixed to a second portion of the rope-type material.

In another broad form, the present invention provides a belt including: an elongate body; and a fastener, the fastener including a first part positioned at a first position along the body and a second part positioned at a second position along the body, the first and second parts being releasably engageable to fasten the belt in a closed looped configuration, wherein at least one of the first and second parts are releasably engageable to the body of the belt such that the size of the loop of the belt is adjustable.

In one form, the first and second parts are releasably engageable to the body of the belt.

In another form, in the closed loop configuration, the elongate body does not travel across the join between the first part and the second part.

In one form, the fastener includes the fastening device of any one of the above forms.

### BRIEF DESCRIPTION OF THE DRAWINGS

This invention may be better understood with reference to the illustrations of embodiments of the invention in which:

FIG. 1 shows a perspective view of an example of a fastening device according to the invention when fastened;

FIG. 2 shows a perspective view of the fastening device of FIG. 1 when unfastened;

FIG. 3 shows a perspective view of an example of one part of a fastening device according to the invention in a loading configuration;

FIG. 4 shows a perspective view of an example of a base part of one part of a fastening device according to the invention;

FIG. 5 shows a perspective view of an example of a base part of a second part of a device according to the invention configured to be engaged with the base part of FIG. 4;

FIG. 6 shows a front perspective view of an example of a cover part according to the invention that may be engaged with the base part of the FIG. 4 or 5; and

FIG. 7 shows a rear perspective view of an example of a cover part according to the invention that may be engaged with the base part of FIG. 2 or 3.

### DETAILED DESCRIPTION

Examples of the present invention provide a fastening device for releasbly joining elongate portions of material. In one example, the fastening device may be used as part of a belt.

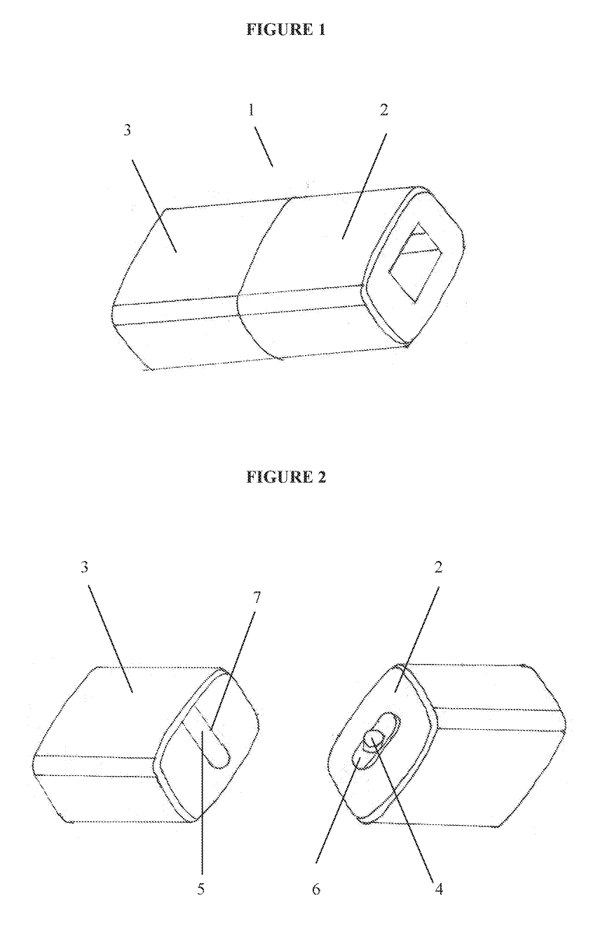

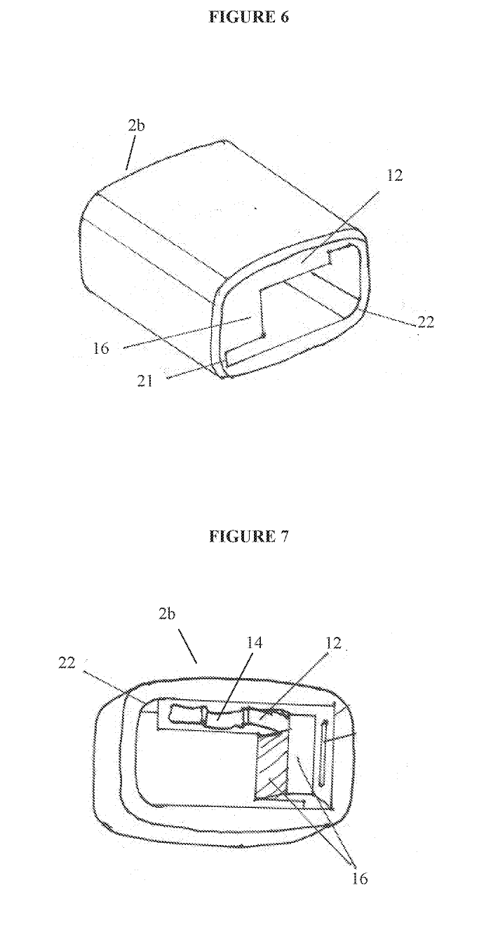

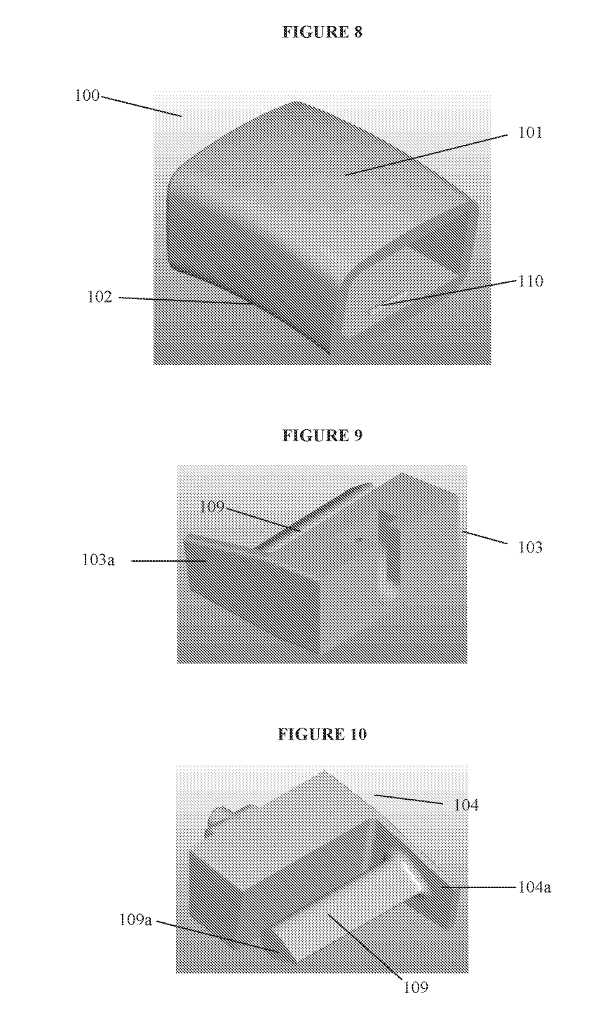

FIGS. 1 to 7 show a fastening device (1) in accordance with one preferred form. The fastening device (1) includes a first part (2) and a second part (3) which are releasably engageable. In the example of the figures, the first part (2) includes a male shaft (4) which is configured to be engaged with a corresponding female recess (5) in the second part (3). The male shaft portion (4) is cross shaped, having transverse arms (6) that are configured to be received within the recess (5) of the second part (3). The recess (5) has an overhanging lip (7) to engage the transverse arms (6). For example, to engage the first and second parts (2, 3), the shaft (4) is inserted into the recess (5) and the first part (2) rotated 90° with respect to the second part (3) such that the transverse arms (6) of the shaft (4) are hooked beneath the lip (7) and the shaft (4) cannot be withdrawn form the recess (5). The first and second parts (2, 3) of the device (1) are thus twist engaged. Once engaged, rotating the first part (2) 90° with respect to the second part (3) allows for disengagement.

FIG. 1 shows the device (1) when the first and second parts are engaged whilst FIG. 2 shows the first and second parts disengaged. It will be appreciated that in alternate forms other engagement mechanisms may be utilised to join/engage first and second parts of the fastening device.

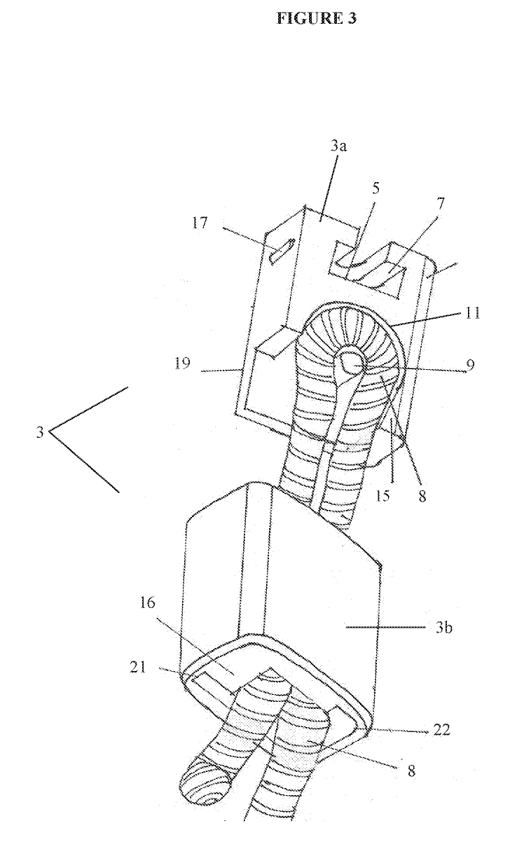

The first and second parts (2, 3) are configured to receive and releasably retain portions of elongate material via a material engagement portion, and typically, a rope type material (8). In addition, the first and second parts (2, 3) are each formed of a base part (2a, 3a) and a cover part (2b, 3b). The base and cover parts are movable between a separated, material loading configuration, and a closed, material retaining, configuration. FIG. 3 shows the separated, material loading configuration of the second part (3).

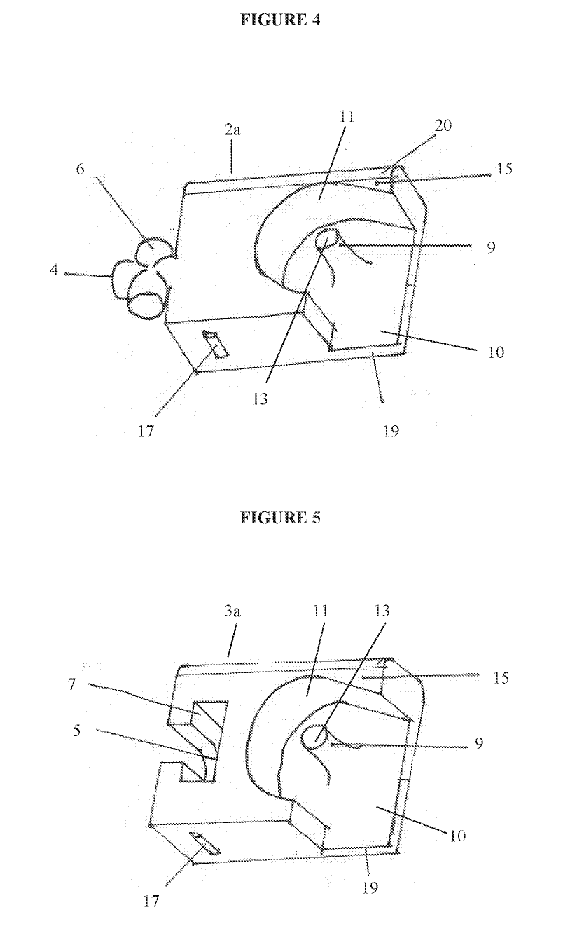

As shown in FIGS. 4 and 5, the base parts (2a, 3a) of the first and second parts (2, 3) are largely the same apart from their engagement elements, which in the base part (2a) of the first part (2) includes a male shaft (4), and in the base part (3a) of the second part (3) includes a female recess (5). It will be appreciated that these male and female parts (4, 5) may be easily interchanged or replaced with other fastening portions that permit releasable engagement between the first and second parts (2, 3).

The base parts (2a, 3a) each include a stem (9) extending from a first wall portion (10) around which the rope type material (8) can be looped and anchored. A curved wall (11) helps to guide the material (8) around the stem (9) and acts to keep the material (8) tight to the stem (9).

The cover parts (2b, 3b) of the first and second parts (2, 3) are substantially the same and are sleeve-like. The cover parts (2b, 3b) are slidingly engaged over the respective base parts (2a, 3a) to a closed configuration wherein a respective wall portion (12) of each cover part (2b or 3b) meets the tip (13) of the stem (9) extending from its corresponding base part (2a or 3a respectively) such that the loop of material cannot be lifted over the tip of the stem (9). The wall portion (12) meeting the stem includes a groove (14) to receive and support the tip (13) of the stem, and minimise the possibility for stem breakage from, for example, an excess pulling force applied to the rope-like material. The base of the stem is also thicker/wider than the tip (13) to provide extra strength.

To further secure the rope-type material (8) within the first and second parts (2, 3), the base (2a, 3a) and cover (2b, 3b) parts include corresponding wedge portions (15, 16) that, as the base and cover parts are moved into the closed configuration, act to clamp the rope type material (8) around the stem portion (9) such that the rope is prevented from removal by pulling on one arm/side of the loop.

To load the rope-type material (see FIG. 3) into the first or second part, the material is folded over to form a loop, and the looped rope (8) is slid through a cover part (e.g. 3b) to be hooked onto the stem (9) of a base part (e.g. 3a). The cover part (e.g. 3b) is subsequently slid over the base part (e.g. 3a) and the corresponding wedges (15, 16) act to clamp and tighten the rope-type material around the stem (9).

The base parts (2a and 3a) also include a raised protrusion (17) on at least one side surface which is configured to engage a corresponding depression (18) on a corresponding internal surface of a respective corresponding cover part (2b, 3b). The base and cover parts thereby reversibly snap lock to substantially maintain the closed configuration until a significant separating force is applied.

Furthermore, to avoid the base parts (2a, 3a) being received in their respective cover parts incorrectly (e.g. upside down), the base parts (2a, 3a) each have a sharp edged side (19) and a curved edge side (20) which correspond to a sharp edged internal surface (21) and curved edge internal surface (22) of the cover parts (2b, 3b). Thus, if misaligned, a base part will not slide into its respective cover part.

The fastening device (1) in combination with the rope-type material may be used as a belt. The releasable engagement between the first and/or second parts and the elongate material allows easy adjustment to a desired waist circumference and also permits interchanging of the device between different belt bodies. The twist engagement between first and second parts also provides easy fastening/unfastening of the belt. It will be appreciated that in alternate forms, either the first or second part could be fixed to the material body of the belt with only the other part removable and repositionable along the material of the belt body.

A further embodiment of the fastening device is shown in FIGS. 8 to 10. In this embodiment, the first and second parts are curved such they have a concave side and a convex side. When engaged, the concave side of the first part is aligned with the concave side of the second part such that, when used as part of a belt buckle, the concavity provided allows the device to sit more readily over the button of a pair of pants or other garment (i.e. the concavity provides space for the button).

As seen in FIG. 8, this embodiment has cover parts (100) that are curved to include a concave wall (101) and convex wall (102). To allow for this curvature, the stems (109) of the base parts (103, 104) extend from a side wall portion (103a, 104a) such that, in the closed configuration, the elongate length of the stem extends substantially parallel to and between the curved walls (101, 102) of a respective cover part. It will be appreciated that each base part (103, 104) includes its own cover part (100).

It will also be appreciated that opposing wedge portions are typcially included the cover part (100) to clamp the loop of material around the stem (109) of a respective base part (e.g. 103 or 104). The cover part (100) also typically includes a groove to receive the tip of the stem (109a). Furthermore, a protrusion (110) is included in the cover part (100) to allow for snap engagement with a corresponding recess in a respective base part (e.g. 103 or 104).

Other forms of the invention may also be provided which address the issue of the device sitting over a garment button. For example, the first and/or second parts may include a depression therein to receive/allow space for the button.

The fastening devices as described may be made of plastic, metal, wood, composite, or other suitable material or combination thereof. In the closed configuration, the cover parts hide the material engagement portion such that the outward appearance the belt appears flat and smooth (see FIGS. 1 and 2 for example).

Although the fastening devices may be used as part of a belt, it should be appreciated that the devices may be used in any suitable circumstance, such as, for example, any situation where two portions of elongate material are required to be joined. For example, the device may be used in the sailing or camping industry to fasten frayed or severed ropes.

It will also be appreciated that the fastening devices, although primarily described as being suitable to join rope type material, may be suitable for fastening other types of elongate material such as conventional belt materials (i.e. flat and elongate). For example the devices may be used to join portions of rope, cable, wire, fibres, twine, string, cord, ribbon or any material that may be manipulated into rope like and/or elongate form. It shall also be appreciated that the fastening devices may join elongate portions of the same, multiple and/or different pieces of material.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

It will be appreciated that various forms of the invention may be used individually or in combination.

1. A fastening device including:
a first part having a material engagement portion, the material engagement portion including a stem for receiving a loop of an elongate portion of material; and
a second part,
wherein the first part is releasably engageable with the second part.

2. A fastening device as claimed in claim 1, wherein the material engagement portion includes a recess, the stem extending substantially from a first wall portion of the recess to a second wall portion of the recess so as to provide an anchor for the loop of the elongate portion of material.

3. A fastening device as claimed in claim 1 or 2, wherein the first part includes a base part and a cover part, the first wall portion forming part of the base part and the second wall portion forming part of the cover part.

4. A fastening device as claimed in claim 3, wherein the base part and cover part are moveable into a loading configuration, wherein the stem does not substantially extend between the first and second wall portions, and a closed configuration wherein the stem extends substantially between the first and second wall portions.

5. A fastening device as claimed in any one of claim 3 or 4, wherein all of the stem extends from the first wall portion providing a stem tip for placement adjacent to the second wall portion.

6. A fastening device as claimed in claim 4 or 5, wherein the base and cover parts are movable between the loading configuration and closed configuration via a sliding engagement/disengagement.

7. A fastening device as claimed in claim 5, wherein the second wall portion includes a groove to receive and support the stem tip.

8. A fastening device as claimed in any one of the preceding claims wherein the cover part is sleeve-like.

9. A fastening device as claimed in any one of the preceding claims, wherein the base part includes a protrusion and the cover part includes a corresponding depression in an internal wall such that the base and cover parts substantially snap engage in the closed configuration.

10. A fastening device as claimed in any one of the preceding claims, wherein the base part includes a curved wall portion to help guide the elongate portion of material around the stem.

11. A fastening device as claimed in claim 4, wherein the base part includes a first wedge portion and the cover part includes a second wedge portion, such that, in the closed configuration, the first and second wedge portions clamp the loop of elongate material around the stem.

12. A fastening device as claimed in anyone of the preceding claims, wherein the first and second parts are twist engaged.

13. A fastening device as claimed in any one of the preceding claims, wherein the second part includes a material engagement portion as defined in any one of the preceding claims in relation to the first part.

14. A belt including a fastening device as claimed in any one of the preceding claims.

15. A belt as claimed in claim 14, wherein the first and second parts of the fastening device are releasably engaged to respective portions of a rope-type material.

16. A belt including a fastening device as claimed in any one of claims 1 to 12, wherein the first part is releasably engaged to a first portion of rope-type material and the second part is fixed to a second portion of the rope-type material.

17. A belt including:
an elongate body; and
a fastener, the fastener including a first part positioned at a first position along the body and a second part positioned at a second position along the body, the first and second parts being releasably engageable to fasten the belt in a closed looped configuration,
wherein at least one of the first and second parts are releasably engageable to the body of the belt such that the size of the loop of the belt is adjustable.

18. A belt as claimed in claim 17, wherein the first and second parts are releasably engageable to the body of the belt.

19. A belt as claimed in claim 17 or 18, wherein, in the closed loop configuration, the elongate body does not travel across the join between the first part and the second part.

20. A belt as claimed in any one of claim 17 to 19, wherein the fastener includes the fastening device of claim 1.

21. A fastening device as claimed in claim 4, wherein the cover part includes first and second opposing wedge portions such that, in the closed configuration, the wedge portions clamp the loop of elongate material around the stem.

22. A fastening device as claimed in any one of claims 1 to 13 and 21, wherein the fastening device is a belt buckle.
